(19) United States
(12) Patent Application Publication
(10) Pub. No.: US 2014/0036974 A1
(43) Pub. Date: Feb. 6, 2014

(54) ADAPTIVE FILTER AND METHOD OF ADAPTIVE FILTERING

(71) Applicant: SAMSUNG ELECTRO-MECHANICS CO., LTD., Gyeonggi-do (KR)

(72) Inventors: Sang Hyun Min, Gyeonggi-do (KR); Yong Il Kwon, Gyeonggi-do (KR); Koon Shik Cho, Gyeonggi-do (KR)

(73) Assignee: SAMSUNG ELECTRO-MECHANICS CO., LTD., Gyeonggi-do (KR)

(21) Appl. No.: 13/951,398

(22) Filed: Jul. 25, 2013

(30) Foreign Application Priority Data
Jul. 31, 2012 (KR) 10-2012-0084027

(51) Int. Cl. H04L 25/03

(52) U.S. Cl. CPC H04L 25/03019
USPC 375/222

(57) ABSTRACT

The present invention relates to an adaptive filter, which includes an analog filter; an analog-digital converter; a modem; a control unit connected to the modem to detect an adjacent interference signal adjacent to an interested channel signal; and a filter control signal generating unit connected to the control unit to generate a filter control signal for controlling a capacity of a variable capacitor, and a method of adaptive filtering and can control a filter passband adaptively to the adjacent interference signal.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2012-0084027, entitled filed Jul. 31, 2012, which is hereby incorporated by reference in its entirety into this application.

### BACKGROUND OF THE INVENTION

1. Field of the Invention

The present invention relates to an adaptive filter and a method of adaptive filtering.

2. Description of the Related Art

A filter that filters the remaining signals except the required signals is one of the essential elements in various communication and signal processing circuits.

In the past, only a filter that is implemented with an analog circuit was mainly used, but in recent times, use of a digital filter has been gradually increased to implement high blocking characteristics for a signal in a relatively low frequency band.

Meanwhile, a representative example of the analog filter is a Butterworth filter shown in FIG. 1. In the Butterworth filter, in order to increase an attenuation rate of a cutoff band, the order of the filter should be increased. That is, FIG. 1 shows a primary Butterworth filter, and the increase of the order of the filter means connection of a plurality of primary Butterworth filters shown in FIG. 1.

When increasing the order of the filter like this, since the number of active elements included in the filter should be increased, current consumption is also increased and the size of the filter is remarkably increased.

FIG. 2 is a view schematically showing gain characteristics of a conventional low pass filter.

Referring to FIG. 2, the conventional low pass filter passes a signal having a frequency of less than 0.5 MHz without attenuation and attenuates a signal of 2 MHz band by about 30 dB and a signal of 4 MHz band by about 50 dB.

Meanwhile, when an adjacent interference signal is introduced through an antenna, after the adjacent interference signal is amplified while passing through a low noise amplifier and converted into an IF frequency after passing through a mixer, in the worst case, a difference between a frequency of the adjacent interference signal and a frequency of an interested channel signal is only 1 MHz.

However, when using the conventional filter having the characteristics shown in FIG. 2, since an attenuation rate of the adjacent interference signal having a difference of only 1 MHz from the frequency of the interested channel signal is only about 15 dB, there is an increased possibility that the interested channel signal is not normally recovered in a modem and so on.

When reducing a passband of the filter unconditionally to improve the blocking characteristics for the adjacent interference signal, since the interested channel signal may be reduced under normal circumstances without the interference signal, reception sensitivity is reduced.

### RELATED ART DOCUMENT

### Patent Document

Patent Document 1: Korean Patent Laid-open Publication No. 10-2008-0029063

### SUMMARY OF THE INVENTION

The present invention has been invented in order to overcome the above-described problems and it is, therefore, an object of the present invention to provide an adaptive filter and a method of adaptive filtering that can control a filter passband adaptively to an adjacent interference signal by controlling a capacity of a variable capacitor provided in an analog filter.

In accordance with one aspect of the present invention to achieve the object, there is provided an adaptive filter including: an analog filter for filtering an RF signal by including a resistor, a comparator, and a variable capacitor; an analog-digital converter for converting the filtered analog signal into a digital signal; a modem connected to the analog-digital converter; a control unit connected to the modem to detect an adjacent interference signal adjacent to an interested channel signal; and a filter control signal generating unit connected to the control unit to generate a filter control signal for controlling a capacity of the variable capacitor, wherein the control unit may control the filter control signal generate unit to maintain a previous state when an interested channel signal packet is received.

At this time, the filter control signal generating unit may generate a signal for increasing the capacity of the variable capacitor when a frequency of the adjacent interference signal is higher than that of the interested channel signal and generate a signal for reducing the capacity of the variable capacitor when the frequency of the adjacent interference signal is lower than that of the interested channel signal.

Further, the control unit may detect the adjacent interference signal from the RF signal when an energy level of the RF signal is higher than a predetermined threshold.

Further, the variable capacitor may include a basic capacitor; an additional capacitor having one end connected to the other end of the basic capacitor; and a switch having one end connected to the other end of the additional capacitor and the other end connected to one end of the basic capacitor while being turned on or off according to the filter control signal.

Further, the analog filter may include a first resistor having one end into which the signal is input; a first comparator having a first terminal connected to the other end of the first resistor and a second terminal grounded; a first variable capacitor having one end connected to the first terminal of the first comparator and the other end connected to an output terminal of the first comparator; a second resistor connected in parallel with the first variable capacitor; a third resistor having one end connected to the output terminal of the first comparator; a second comparator having a first terminal connected to the other end of the third resistor and a second terminal grounded; a second variable capacitor having one end connected to the first terminal of the second comparator; a third comparator having an output terminal connected to the other end of the second variable capacitor and a first terminal grounded; a sixth resistor having one end connected to the output terminal of the third comparator and the other end connected to a second terminal of the third comparator; a seventh resistor having one end connected to the second terminal of the third comparator and the other end connected to an output terminal of the second comparator; a fourth resistor having one end connected to the first terminal of the first comparator and the other end connected to the other end of the seventh resistor; and a fifth resistor having one end connected to the output terminal of the first comparator, wherein the first terminal of the first comparator and the other end of the fifth resistor may be an output terminal of the analog filter.

In accordance with another aspect of the present invention to achieve the object, there is provided an adaptive filter including: an analog filter for filtering an RF signal by including a resistor, a comparator, and a variable capacitor; an analog-digital converter for converting the filtered analog signal into a digital signal; a modem connected to the analog-digital converter; a control unit connected to the modem to detect an adjacent interference signal adjacent to an interested channel signal; and a filter control signal generating unit connected to the control unit to generate a filter control signal for controlling a capacity of the variable capacitor.

At this time, the control unit may include a signal receiving unit connected to the analog-digital converter and the modem; an interested channel signal packet reception determining unit connected to the signal receiving unit to determine whether an interested channel signal packet is received; an energy level determining unit connected to the signal receiving unit to determine an energy level of the received signal; and a signal detecting unit connected to the signal receiving unit, the interested channel signal packet reception determining unit, and the energy level determining unit to detect the adjacent interference signal.

Further, the filter control signal generating unit may generate a signal for increasing the capacity of the variable capacitor when a frequency of the adjacent interference signal detected by the signal detecting unit is higher than that of the interested channel signal and generate a signal for reducing the capacity of the variable capacitor when the frequency of the adjacent interference signal detected by the signal detecting unit is lower than that of the interested channel signal.

Further, the signal detecting unit may detect the adjacent interference signal only in a state in which the interested channel signal packet reception determining unit checks that the interested channel signal packet is not received.

Further, the signal detecting unit may detect the adjacent interference signal only in a state in which the energy level determining unit determines that the energy level is higher than a predetermined threshold by comparing the energy level with the predetermined threshold.

In accordance with still another aspect of the present invention to achieve the object, there is provided a method of adaptive filtering for attenuating an adjacent interference signal included in an RF signal using an analog filter including a variable capacitor, including the steps of: detecting the adjacent interference signal while receiving the RF signal; determining whether an interested channel signal packet is received by being included in the RF signal; comparing an energy level of the RF signal with a predetermined threshold when the interested channel signal packet is not received; and attenuating the detected adjacent interference signal by adjusting a passband of the analog filter when the energy level of the received signal is higher than the threshold.

At this time, the step of detecting the adjacent interference signal may include a process of detecting a frequency of the adjacent interference signal.

Further, the frequency of the adjacent interference signal may be detected by a fast Fourier transform (FFT) algorithm.

Further, the frequency of the adjacent interference signal may be detected by a zero-crossing counting method.

Further, the step of attenuating the detected adjacent interference signal by adjusting the passband of the analog filter may adjust the passband of the analog filter by adjusting a capacity of the variable capacitor of the analog filter.

Further, the adjustment of the capacity of the variable capacitor may increase the capacity of the variable capacitor when the frequency of the adjacent interference signal is higher than that of an interested channel signal and reduce the capacity of the variable capacitor when the frequency of the adjacent interference signal is lower than that of the interested channel signal.

In accordance with still another aspect of the present invention to achieve the object, there is provided a method of adaptive filtering for attenuating an adjacent interference signal included in an RF signal using an analog filter including a variable capacitor, including the steps of: receiving the RF signal; determining whether an interested channel signal packet is received by being included in the RF signal; comparing an energy level of the RF signal with a predetermined threshold when the interested channel signal packet is not received; detecting the adjacent interference signal when the energy level of the received signal is higher than the threshold; and attenuating the detected adjacent interference signal by adjusting a passband of the analog filter according to a frequency of the adjacent interference signal.

At this time, the step of attenuating the detected adjacent interference signal by adjusting the passband of the analog filter may adjust the passband of the analog filter by increasing a capacity of the variable capacitor when the frequency of the adjacent interference signal is higher than that of an interested channel signal and reducing the capacity of the variable capacitor when the frequency of the adjacent interference signal is lower than that of the interested channel signal.

Further, the method of adaptive filtering may further include the step of returning the capacity of the variable capacitor to an initial value when the reception of the interested channel signal packet is completed.

Further, the method of adaptive filtering may further include the step of returning the capacity of the variable capacitor to an initial value when the adjacent interference signal included in the RF signal is reduced to below a predetermined level.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing a conventional primary Butterworth filter;

FIG. 2 is a view schematically showing gain characteristics of a conventional low pass filter;

FIG. 3 is a view schematically showing an adaptive filter in accordance with an embodiment of the present invention;

FIG. 4 is a view schematically showing a control unit of the adaptive filter in accordance with an embodiment of the present invention;

FIG. 5 is a view schematically showing bandwidth variation characteristics of a filter according to changes in capacity of a capacitor provided in the filter;

FIG. 6 is a view schematically showing an analog filter of the adaptive filter in accordance with an embodiment of the present invention;

FIG. 7 is a view schematically showing a variable capacitor provided in the analog filter of the adaptive filter in accordance with an embodiment of the present invention;

FIG. 8 is a view schematically showing filter gain characteristics and changes in size of a signal after passing through a filter at the time of applying the adaptive filter in accordance with an embodiment of the present invention when power of an adjacent interference signal is low;

FIG. 9 is a view schematically showing filter gain characteristics and changes in size of a signal after passing through a filter at the time of applying the adaptive filter in accordance with an embodiment of the present invention when power of an adjacent interference signal is greater than that of an interested channel signal and a frequency of the adjacent interference signal is higher than that of the interested channel signal;

FIG. 10 is a view schematically showing filter gain characteristics and changes in size of a signal after passing through a filter at the time of applying the adaptive filter in accordance with an embodiment of the present invention when power of an adjacent interference signal is greater than that of an interested channel signal and a frequency of the adjacent interference signal is lower than that of the interested channel signal;

FIG. 11 is a view schematically showing a method of adaptive filtering in accordance with an embodiment of the present invention;

FIG. 12 is a view schematically showing a method of adaptive filtering in accordance with another embodiment of the present invention; and

FIG. 13 is a view schematically showing a method of adaptive filtering in accordance with still another embodiment of the present invention.

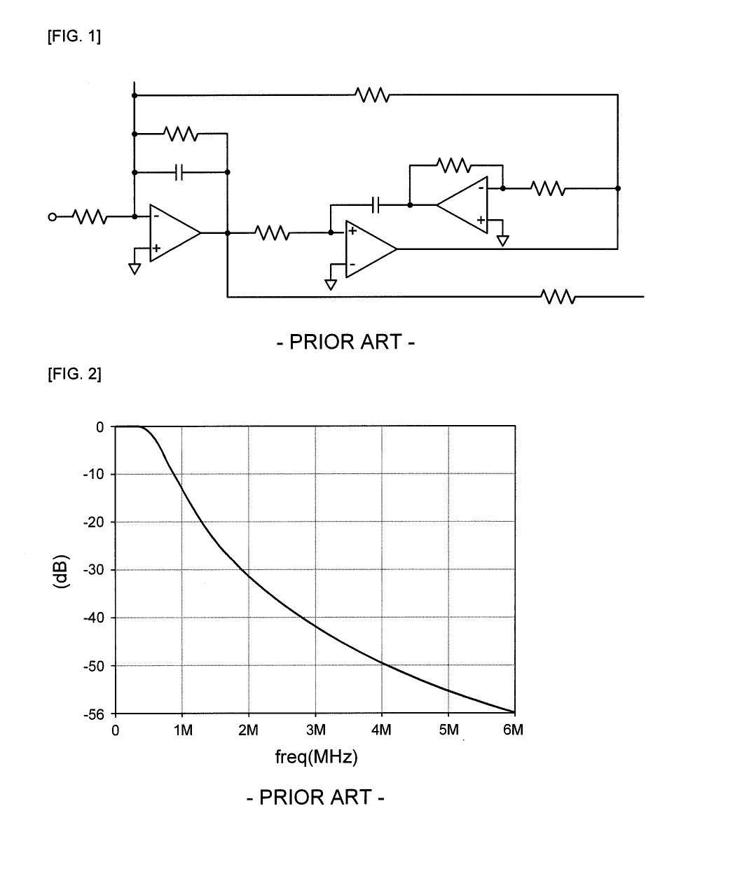

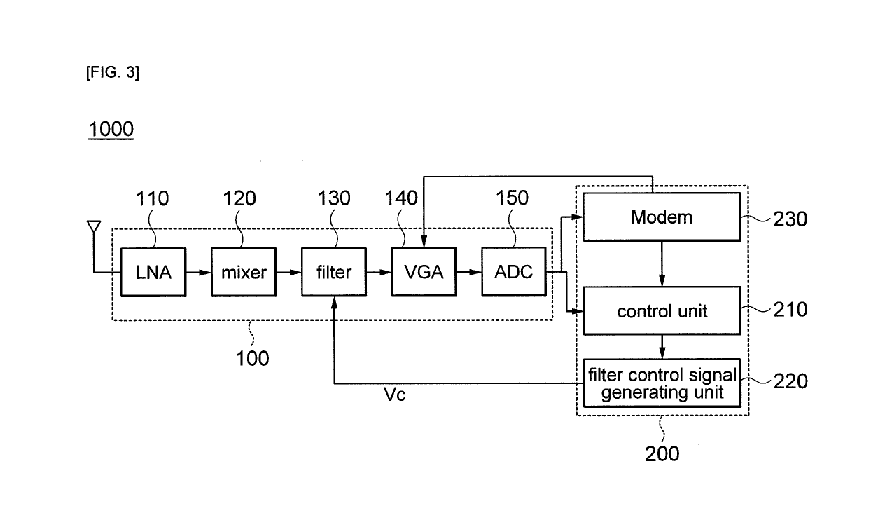

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. The same reference numerals refer to the same elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help understanding of embodiments of the present invention. The same reference numerals in different figures denote the same elements and the similar reference numerals do not necessarily all refer to the similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Hereinafter, configuration and operational effect of the present invention will be described in detail with reference to the drawings.

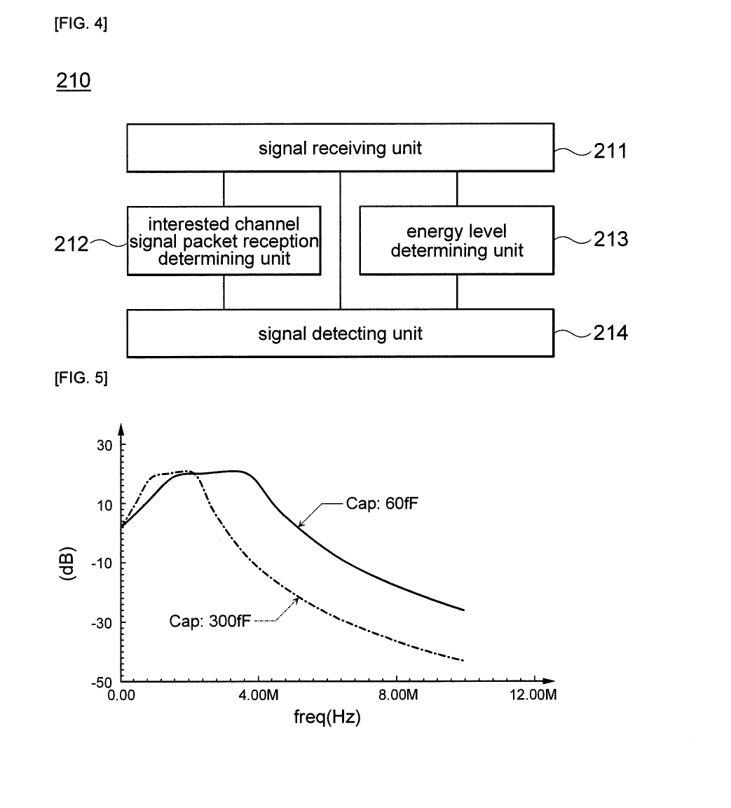

FIG. 3 is a view schematically showing an adaptive filter 1000 in accordance with an embodiment of the present invention, and FIG. 4 is a view schematically showing a control unit 210 of the adaptive filter 1000 in accordance with an embodiment of the present invention.

Referring to FIG. 3, the adaptive filter 1000 in accordance with an embodiment of the present invention may include an analog filter 130, an analog-digital converter 150, a modem 230, a control unit 210, and a filter control signal generating unit 220.

At this time, the analog filter 130 may be implemented with a conventional typical analog filter 130 including a resistor, a comparator, and a capacitor. However, the analog filter 130 in accordance with an embodiment of the present invention should be capable of adjusting a signal passband by including a variable capacitor.

The analog-digital converter 150 (ADC) performs a function of converting an analog signal into a digital signal and may be implemented with a typical ADC.

Meanwhile, as shown in FIG. 3, a low noise amplifier (LNA) 110 and a mixer 120 may be provided between the analog filter 130 and an antenna according to the need, and a variable gain amplifier (VGA) 140 may be provided between an output terminal of the analog filter 130 and the ADC 150.

A portion including the analog filter 130 and the ADC 150 described above may be referred to as an analog processing unit 100.

Next, the modem 230, the control unit 210, and the filter control signal generating unit 220 may be referred to as a digital processing unit 200 and will be specifically described below.

First, the modem 230 is connected to the ADC 150 to perform a function of recovering an interested channel signal from the digital signal.

At this time, the modem 230 may be connected to the above-described VGA 140 to adjust an amplification rate of the VGA 140.

The control unit 210 is connected to the modem 230 to perform a function of processing the digital signal.

Further, the control unit 210 may perform a function of detecting an adjacent interference signal adjacent to the interested channel signal.

Meanwhile, referring to FIG. 4, the control unit 210 may include a signal receiving unit 211, an interested channel signal packet reception determining unit 212, an energy level determining unit 213, and a signal detecting unit 214.

The signal receiving unit 211 is connected to the ADC 150 and the modem 230 to receive the digital signal.

At this time, the signal receiving unit 211 may receive information on reception of an interested channel signal packet from the modem 230.

Further, the interested channel signal packet reception determining unit 212 performs a function of determining whether the interested channel signal packet is received or not based on the information on the reception of the interested channel signal packet received from the modem 230.

Further, the energy level determining unit 213 performs a function of determining an energy level of the signal received by the adaptive filter 1000, particularly, may compare the energy level with a predetermined threshold to output the result of comparison.

At this time, the energy level may be usually referred to as a received signal strength indication (RSSI) value and measured by further providing an analog circuit, which can detect the RSSI value, in the above-described analog processing unit 100.

Further, the signal detecting unit 214 may be connected to the signal receiving unit 211, the interested channel signal packet reception determining unit 212, and the energy level determining unit 213 to perform a function of detecting the adjacent interference signal adjacent to the interested channel signal.

At this time, the detection of the adjacent interference signal may mean detection of a frequency or size of the adjacent interference signal.

Here, a method of detecting the frequency of the adjacent interference signal may be a method of applying a fast Fourier transform (FFT) algorithm, a zero-crossing counting method, and so on.

First, the FFT algorithm is a typically widely used method for analysis of a frequency of a signal. Since materials for the FFT algorithm and implementation methods are well known, detailed description thereof will be omitted and simply described.

When performing an FFT operation on the received signal, in order to design a high frequency resolution compared to a sampling frequency (actually, analysis is performed on up to only ½ of the sampling frequency), an FFT block has a large size when implemented, thus causing an increase in power consumption.

On the contrary, when the frequency resolution is very low, the size of the FFT block and the power consumption are much reduced.

In case of the adaptive filter 1000 in accordance with an embodiment of the present invention, when the sampling frequency is 8 MHz, it is possible to sufficiently detect the adjacent interference signal only by designing the frequency resolution with about 1 MHz or 0.5 MHz.

When designed like this, it is possible to implement an algorithm with very low complexity of about 8 or 16 point FFT described in general textbooks on the FFT as an example.

However, when the resolution is low, the result of frequency analysis may be inaccurate due to the influence of noise. The influence of various errors caused by noise or arithmetic precision can be reduced by using a method of accumulating and averaging the results of performing FFT for a predetermined time.

Next, the zero-crossing counting method will be described.

When an IF carrier signal is loaded on a signal, the number of times the signal is changed to a positive or negative value varies. This is similar to the concept of frequency we often say.

Therefore, when measuring the number of times the signal changes from positive to negative or from negative to positive, it is possible to analyze the approximate frequency of the current signal. The frequency detection performed in this way may be referred to as the zero-crossing counting method.

Meanwhile, the frequency of the signal may be detected as an absolute value of the count or it is possible to determine whether the signal is an interference signal having a frequency higher than that of an interested channel signal or an interference signal having a frequency lower than that of the interested channel signal by sufficiently measuring a count value for IF frequency of the interested channel signal in advance and determining whether the frequency of the signal is greater or smaller than the count value.

In the adaptive filter 1000 in accordance with an embodiment of the present invention, it is possible to implement a sufficient effect according to adjustment of a passband only by detecting the frequency of the adjacent interference signal in the unit of about 1 MHz.

Therefore, the signal detecting unit 214 of the adaptive filter 1000 in accordance with an embodiment of the present invention can detect the frequency of the adjacent interference signal by applying a zero-crossing counting method that can relatively simply analyze a frequency of a specific signal.

The filter control signal generating unit 220 is connected to the above-described control unit 210 to perform a function of generating a filter control signal for controlling a capacity of the variable capacitor of the analog filter 130.

FIG. 5 is a view schematically showing bandwidth variation characteristics of a filter according to changes in capacity of a capacitor provided in the filter.

Referring to FIG. 5, it is possible to understand that a passband of the filter is changed according to changes in the capacity of the capacitor provided in the filter. That is, when a capacitance is about 60 fF, an RF signal up to 4 MHz can pass without attenuation, but when the capacitance is about 300 fF, an RF signal up to 2 MHz can pass without attenuation.

By applying this principle, in the adaptive filter 1000 in accordance with an embodiment of the present invention, the variable capacitor is provided in the analog filter 130 and the filter control signal generating unit 220 is provided to control the capacity of the variable capacitor.

Furthermore, the filter control signal generating unit 220 is connected to the control unit 210, which detects the adjacent interference signal, and generates a signal for controlling the capacity of the variable capacitor to increase an attenuation rate of the adjacent interference signal using the existence, size, and frequency of the adjacent interference signal.

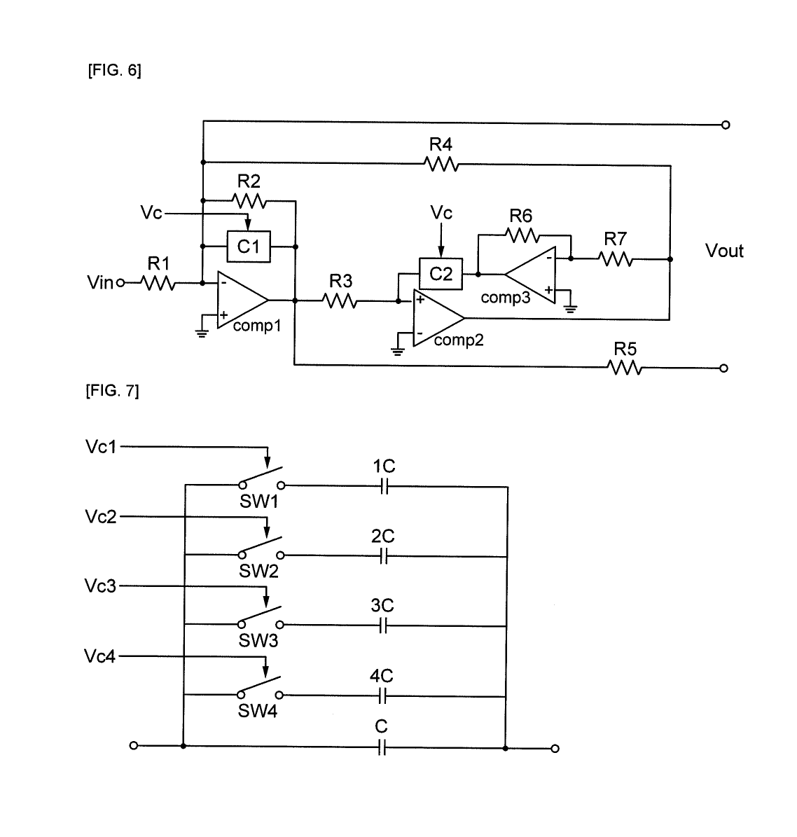

FIG. 6 is a view schematically showing the analog filter 130 of the adaptive filter 1000 in accordance with an embodiment of the present invention.

Referring to FIG. 6, the analog filter 130 included in the adaptive filter 1000 in accordance with an embodiment of the present invention may be implemented in a similar shape to a conventional Butterworth filter.

However, the variable capacitor should be provided instead of a conventional capacitor.

The RF signal received through the antenna is input into an inverting terminal of a first comparator comp1 through a first resistor R1.

At this time, the signal passing through the antenna may pass through the LNA 110 and the mixer 120 according to the need.

A non-inverting terminal of the first comparator comp1 is grounded, and one ends of a first variable capacitor C1, a second resistor R2, and a fourth resistor R4 and an output terminal of the filter are connected to the inverting terminal of the first comparator comp1.

Further, the other ends of the first variable capacitor C1 and the second resistor R2 are connected to an output terminal of the first comparator comp1.

Further, the output terminal of the first comparator comp1 is connected to an inverting terminal of a second comparator comp2 of which the inverting terminal is grounded with a third resistor R3 interposed therebetween.

Further, one end of a second variable capacitor C2 is connected to the inverting terminal of the second comparator comp2, and the other end thereof is connected to an output terminal of a third comparator comp3.

A non-inverting terminal of the third comparator comp3 is grounded, and an inverting terminal thereof is connected to one end of a sixth resistor R6 and one end of a seventh resistor R7.

At this time, the other end of the sixth resistor R6 is connected to the output terminal of the third comparator comp3, and the other end of the seventh resistor R7 is connected to an output terminal of the second comparator comp2 and the other end of the fifth resistor R4.

Further, one end of the fifth resistor R5 is connected to the output terminal of the first comparator comp1, and the other end of the fifth resistor R5 and the inverting terminal of the first comparator comp1 form the output terminal of the analog filter 130.

Accordingly, the analog filter 130 including the first variable capacitor C1 and the second variable capacitor C2 can be implemented.

FIG. 7 is a view schematically showing the variable capacitor provided in the analog filter 130 of the adaptive filter 1000 in accordance with an embodiment of the present invention.

Referring to FIG. 7, the variable capacitor may include a plurality of additional capacitors 1C, 2C, 3C, and 4C which are connected in parallel with a basic capacitor C. At this time, the respective additional capacitors 1C, 2C, 3C, and 4C may be implemented to be connected in parallel with the basic capacitor C or disconnected from the basic capacitor C by switches SW1, SW2, SW3, and SW4.

Further, the switches SW1, SW2, SW3, and SW4 may be selectively turned on or off according to control signals Vc1, Vc2, Vc3, and Vc4 generated by the above-described filter control signal generating unit 220. Accordingly, it is possible to adjust the capacity of the above-described first variable capacitor C1 and second variable capacitor C2.

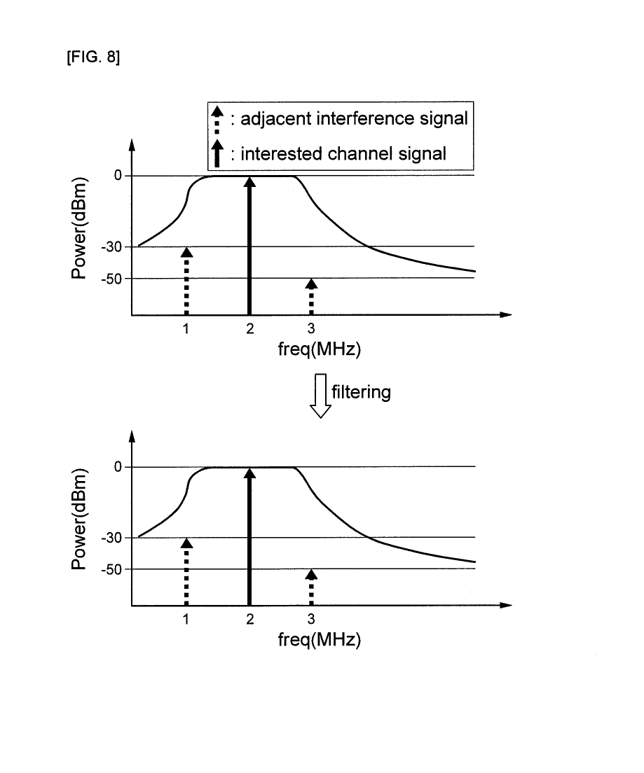

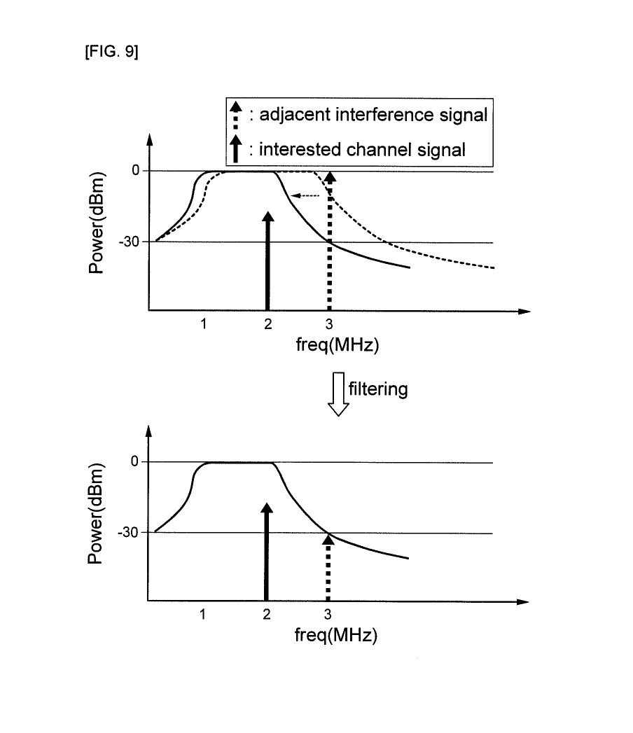

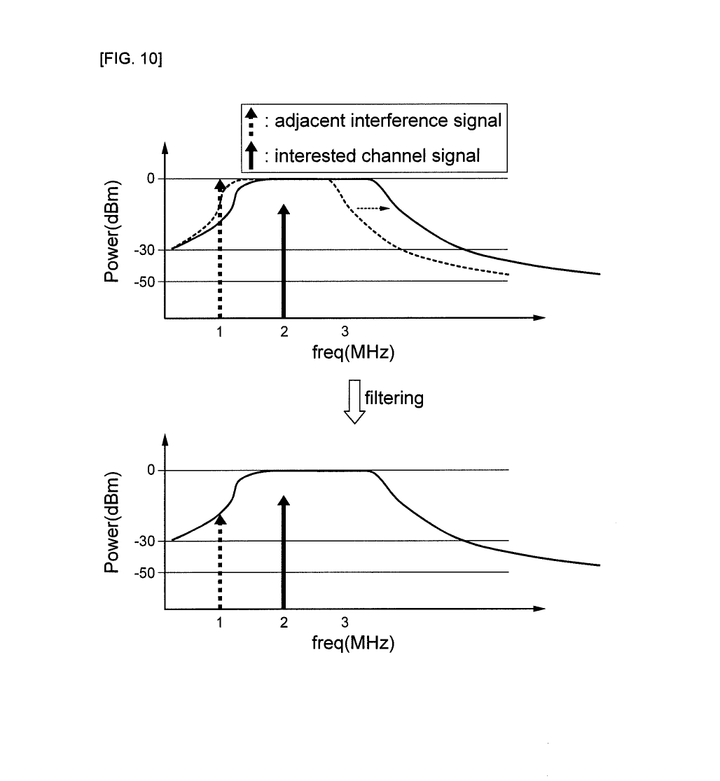

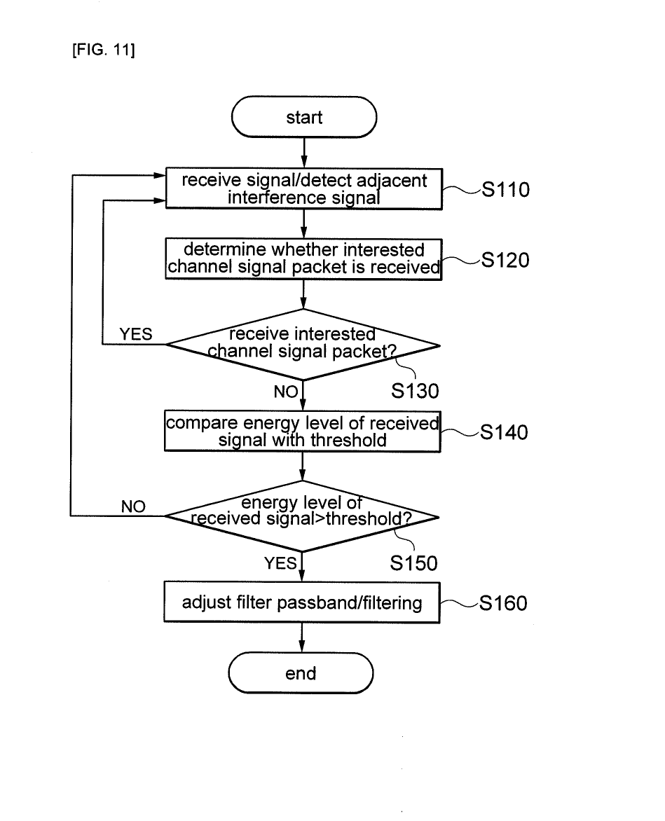

FIG. 8 is a view schematically showing filter gain characteristics and changes in the size of a signal after passing through a filter at the time of applying the adaptive filter 1000 in accordance with an embodiment of the present invention when power of an adjacent interference signal is low, FIG. 9 is a view schematically showing filter gain characteristics and changes in size of a signal after passing through a filter at the time of applying the adaptive filter 1000 in accordance with an embodiment of the present invention when power of the adjacent interference signal is greater than that of an interested channel signal and a frequency of the adjacent interference signal is higher than that of the interested channel signal, and FIG. 10 is a view schematically showing filter gain characteristics and changes in size of a signal after passing through a filter at the time of applying the adaptive filter 1000 in accordance with an embodiment of the present invention when power of the adjacent interference signal is greater than that of an interested channel signal and a frequency of the adjacent interference signal is lower than that of the interested channel signal.

Referring to FIGS. 8 to 10, when the power of the adjacent interference signal is smaller than that of the interested channel signal, it is possible to maintain the passband of the analog filter 130 at a basic value.

However, when it is detected that the adjacent interference signal having greater power than the interested channel signal exists in a region higher than the frequency of the interested channel signal, it is possible to improve the attenuation rate of the adjacent interference signal by increasing the capacity of the variable capacitor.

On the contrary, when it is detected that the adjacent interference signal having greater power than the interested channel signal exists in a region lower than the frequency of the interested channel signal, it is possible to improve the attenuation rate of the adjacent interference signal by reducing the capacity of the variable capacitor.

Accordingly, it is possible to adjust the passband of the analog filter 130 in order to effectively attenuate the detected adjacent interference signal.

Meanwhile, in the adaptive filter 1000 in accordance with an embodiment of the present invention, the passband of the analog filter 130 is adjusted according to the reception and energy level of the interested channel signal packet.

However, although the interested channel signal packet is introduced with an energy level higher than the threshold, when an energy level signal is detected before the signal for informing whether the interested channel signal packet is received, if the filter is controlled right after checking whether the energy level exceeds the threshold, malfunctions may occur.

Further, when measuring the frequency of the adjacent interference signal, if the passband of the analog filter 130 is adjusted or reduced, measurement accuracy of the frequency of the adjacent interference signal may be deteriorated.

For example, when the adjacent interference signal exists before the interested channel signal packet is introduced, the adjacent signal is much suppressed by reducing the center frequency and width of the passband of the analog filter 130.

When the interested channel signal packet is introduced in this state, a change in the energy level may occur before checking information on the introduction of the interested channel signal packet. Further, when the bandwidth of the analog filter 130 is changed to an initial bandwidth or a wide bandwidth to perform the detection of the adjacent interference signal again considering only the change of the energy level, the size of the adjacent interference signal, which has been suppressed, is suddenly increased, thus causing interested channel signal packet data to be buried in the interference signal during a period of measuring the adjacent interference signal.

Therefore, in the adaptive filter 1000 in accordance with an embodiment of the present invention, it is preferred that the passband of the analog filter 130, that is, the capacity of the variable capacitor of the analog filter 130 is not changed in a state in which the interested channel signal packet is being received.

At this time, when the interested channel signal packet is received, the process of detecting the adjacent interference signal may not be performed.

Further, when the interested channel signal packet is received, the capacity of the variable capacitor of the analog filter 130 may not be adjusted even though the detection of the adjacent interference signal is continuously performed.

Further, when the reception of the interested channel signal packet is completed in a state in which the capacity of the variable capacitor of the analog filter 130 is adjusted, it is preferred that the capacity of the variable capacitor of the analog filter 130 is initialized.

Further, when the adjacent interference signal included in the RF signal is reduced to below a predetermined level, it is preferred that the capacity of the variable capacitor is returned to an initial value.

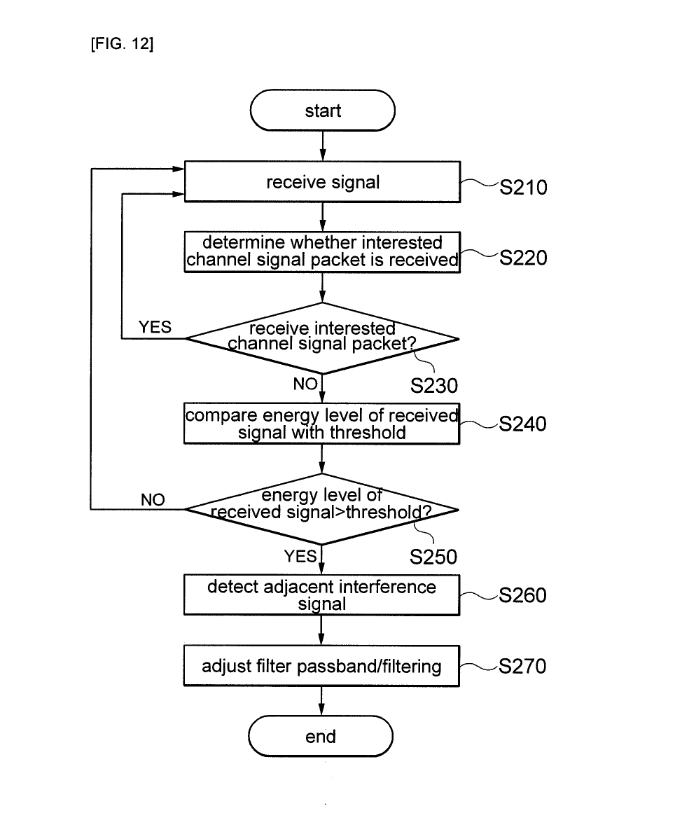

FIG. 11 is a view schematically showing a method of adaptive filtering in accordance with an embodiment of the present invention.

Referring to FIG. 11, the method of adaptive filtering in accordance with an embodiment of the present invention, first, performs a process of detecting an adjacent interference signal included in an RF signal while receiving the RF signal (S110).

At this time, a frequency of the adjacent interference signal may also be detected in the process of detecting the adjacent interference signal.

Further, the above-described FFT or zero-crossing method may be applied as a method of detecting the frequency of the adjacent interference signal.

Next, it is determined whether an interested channel signal packet is received by being included in the RF signal (S120).

Next, when the interested channel signal packet is not received, an energy level of the received signal is compared with a predetermined threshold (S140).

At this time, when the interested channel signal packet is not received, the flow is fed back to the step S110.

Next, when the energy level of the received signal is higher than the threshold, filtering is performed by adjusting a filter passband of an analog filter 130 (S150).

Here, the filter passband of the analog filter 130 is implemented by adjusting a capacity of a variable capacitor.

Further, the capacity of the variable capacitor can be adjusted by increasing the capacity of the variable capacitor when the frequency of the adjacent interference signal is higher than that of the interested channel signal and, on the contrary, reducing the capacity of the variable capacitor when the frequency of the adjacent interference signal is lower than that of the interested channel signal.

At this time, the flow is fed back to the step S110 when the energy level of the received signal is not higher than the threshold.

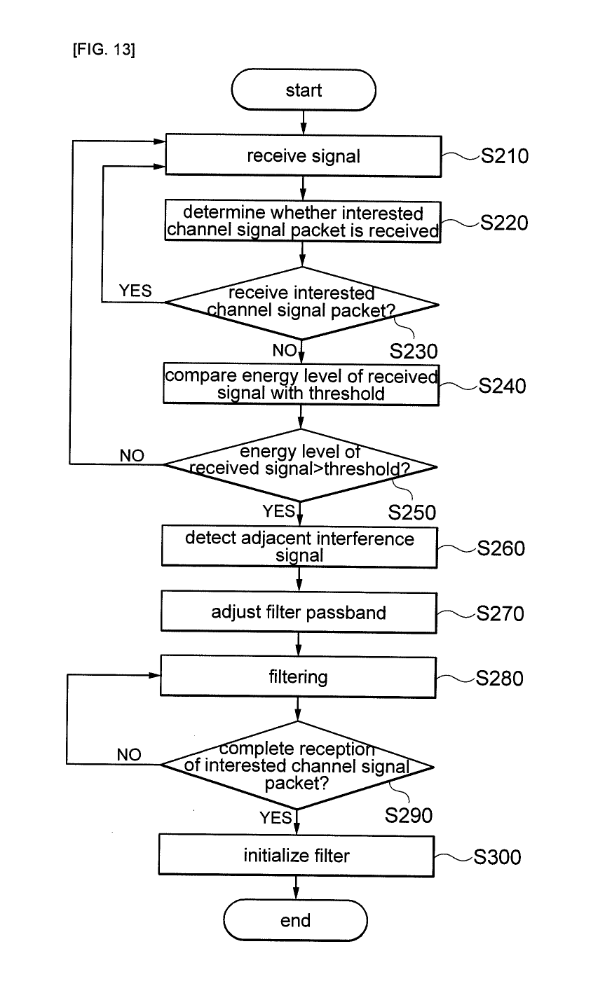

FIG. 12 is a view schematically showing a method of adaptive filtering in accordance with another embodiment of the present invention, and FIG. 13 is a view schematically showing a method of adaptive filtering in accordance with still another embodiment of the present invention.

Referring to FIGS. 12 and 13, the method of adaptive filtering in accordance with the present embodiment performs detection of an adjacent interference signal later, unlike the embodiment described above with reference to FIG. 11.

Specifically, when an interested channel signal packet is not received, an energy level of the received signal is compared with a threshold (S230, S240, S250), and the detection of the adjacent interference signal starts only when the energy level of the received signal is higher than the threshold (S260).

Next, a filter passband of an analog filter 130 is adjusted by reflecting information on the detected adjacent interference signal, and filtering is performed (S270) in a state in which the passband is adjusted to efficiently attenuate the adjacent interference signal.

Meanwhile, as shown in FIG. 13, it is checked whether the reception of the interested channel signal packet is completed (S290) while performing a filtering process (S280), and it is preferred that the filter is initialized when the reception of the interested channel signal packet is completed (S300).

Here, the initialization of the filter means that the passband of the analog filter 130 is returned to a default value. That is, it is possible to initialize the passband of the analog filter 130 to a passband formed by a basic capacitor by making all filter control signals for controlling a variable capacitor of the analog filter 130 off.

The present invention configured as above can effectively attenuate the adjacent interference signal by adaptively adjusting the passband of the analog filter according to the existence and frequency of the adjacent interference signal.

Further, while the conventional analog filter has difficulty in miniaturization and increased power consumption since the order of the conventional analog filter should be increased to improve band-pass characteristics, the present invention is advantageous to miniaturization and low power consumption by implementing efficient blocking of the adjacent interference signal without increasing the order of the analog filter.

What is claimed is:

1. An adaptive filter comprising:
an analog filter for filtering an RF signal by comprising a resistor, a comparator, and a variable capacitor;
an analog-digital converter for converting the filtered analog signal into a digital signal;
a modem connected to the analog-digital converter;
a control unit connected to the modem to detect an adjacent interference signal adjacent to an interested channel signal; and
a filter control signal generating unit connected to the control unit to generate a filter control signal for controlling a capacity of the variable capacitor, wherein the control unit controls the filter control signal generate unit to maintain a previous state when an interested channel signal packet is received.

2. The adaptive filter according to claim 1, wherein the filter control signal generating unit generates a signal for increasing the capacity of the variable capacitor when a frequency of the adjacent interference signal is higher than that of the interested channel signal and generates a signal for reducing the capacity of the variable capacitor when the frequency of the adjacent interference signal is lower than that of the interested channel signal.

3. The adaptive filter according to claim 2, wherein the control unit detects the adjacent interference signal from the RF signal when an energy level of the RF signal is higher than a predetermined threshold.

4. The adaptive filter according to claim 3, wherein the variable capacitor comprises:
a basic capacitor;
an additional capacitor having one end connected to the other end of the basic capacitor; and
a switch having one end connected to the other end of the additional capacitor and the other end connected to one end of the basic capacitor while being turned on or off according to the filter control signal.

5. The adaptive filter according to claim 3, wherein the analog filter comprises:
a first resistor having one end into which the signal is input;
a first comparator having a first terminal connected to the other end of the first resistor and a second terminal grounded;
a first variable capacitor having one end connected to the first terminal of the first comparator and the other end connected to an output terminal of the first comparator;
a second resistor connected in parallel with the first variable capacitor;
a third resistor having one end connected to the output terminal of the first comparator;
a second comparator having a first terminal connected to the other end of the third resistor and a second terminal grounded;
a second variable capacitor having one end connected to the first terminal of the second comparator;
a third comparator having an output terminal connected to the other end of the second variable capacitor and a first terminal grounded;
a sixth resistor having one end connected to the output terminal of the third comparator and the other end connected to a second terminal of the third comparator;
a seventh resistor having one end connected to the second terminal of the third comparator and the other end connected to an output terminal of the second comparator;
a fourth resistor having one end connected to the first terminal of the first comparator and the other end connected to the other end of the seventh resistor; and
a fifth resistor having one end connected to the output terminal of the first comparator, wherein the first terminal of the first comparator and the other end of the fifth resistor are an output terminal of the analog filter.

6. An adaptive filter comprising:
an analog filter for filtering an RF signal by comprising a resistor, a comparator, and a variable capacitor;
an analog-digital converter for converting the filtered analog signal into a digital signal;
a modem connected to the analog-digital converter;
a control unit connected to the modem to detect an adjacent interference signal adjacent to an interested channel signal; and
a filter control signal generating unit connected to the control unit to generate a filter control signal for controlling a capacity of the variable capacitor.

7. The adaptive filter according to claim 6, wherein the control unit comprises:
a signal receiving unit connected to the analog-digital converter and the modem;
an interested channel signal packet reception determining unit connected to the signal receiving unit to determine whether an interested channel signal packet is received;
an energy level determining unit connected to the signal receiving unit to determine an energy level of the received signal; and
a signal detecting unit connected to the signal receiving unit, the interested channel signal packet reception determining unit, and the energy level determining unit to detect the adjacent interference signal.

8. The adaptive filter according to claim 7, wherein the filter control signal generating unit generates a signal for increasing the capacity of the variable capacitor when a frequency of the adjacent interference signal detected by the signal detecting unit is higher than that of the interested channel signal and generates a signal for reducing the capacity of the variable capacitor when the frequency of the adjacent interference signal detected by the signal detecting unit is lower than that of the interested channel signal.

9. The adaptive filter according to claim 8, wherein the signal detecting unit detects the adjacent interference signal only in a state in which the interested channel signal packet reception determining unit checks that the interested channel signal packet is not received.

10. The adaptive filter according to claim 9, wherein the signal detecting unit detects the adjacent interference signal only in a state in which the energy level determining unit determines that the energy level is higher than a predetermined threshold by comparing the energy level with the predetermined threshold.

11. The adaptive filter according to claim 10, wherein the variable capacitor comprises:
a basic capacitor;
an additional capacitor having one end connected to the other end of the basic capacitor; and
a switch having one end connected to the other end of the additional capacitor and the other end connected to one end of the basic capacitor while being turned on or off according to the filter control signal.

12. The adaptive filter according to claim 10, wherein the analog filter comprises:
a first resistor having one end into which the signal is input;
a first comparator having a first terminal connected to the other end of the first resistor and a second terminal grounded;
a first variable capacitor having one end connected to the first terminal of the first comparator and the other end connected to an output terminal of the first comparator;
a second resistor connected in parallel with the first variable capacitor;
a third resistor having one end connected to the output terminal of the first comparator;
a second comparator having a first terminal connected to the other end of the third resistor and a second terminal grounded;
a second variable capacitor having one end connected to the first terminal of the second comparator;
a third comparator having an output terminal connected to the other end of the second variable capacitor and a first terminal grounded;
a sixth resistor having one end connected to the output terminal of the third comparator and the other end connected to a second terminal of the third comparator;
a seventh resistor having one end connected to the second terminal of the third comparator and the other end connected to an output terminal of the second comparator;
a fourth resistor having one end connected to the first terminal of the first comparator and the other end connected to the other end of the seventh resistor; and
a fifth resistor having one end connected to the output terminal of the first comparator, wherein the first terminal of the first comparator and the other end of the fifth resistor are an output terminal of the analog filter.

13. A method of adaptive filtering for attenuating an adjacent interference signal included in an RF signal using an analog filter comprising a variable capacitor, comprising:
detecting the adjacent interference signal while receiving the RF signal;
determining whether an interested channel signal packet is received by being included in the RF signal;
comparing an energy level of the RF signal with a predetermined threshold when the interested channel signal packet is not received; and
attenuating the detected adjacent interference signal by adjusting a passband of the analog filter when the energy level of the received signal is higher than the threshold.

14. The method of adaptive filtering according to claim 13, wherein detecting the adjacent interference signal comprises a process of detecting a frequency of the adjacent interference signal.

15. The method of adaptive filtering according to claim 14, wherein the frequency of the adjacent interference signal is detected by a fast Fourier transform (FFT) algorithm.

16. The method of adaptive filtering according to claim 14, wherein the frequency of the adjacent interference signal is detected by a zero-crossing counting method.

17. The method of adaptive filtering according to claim 14, wherein attenuating the detected adjacent interference signal by adjusting the passband of the analog filter adjusts the passband of the analog filter by adjusting a capacity of the variable capacitor of the analog filter.

18. The method of adaptive filtering according to claim 17, wherein the adjustment of the capacity of the variable capacitor increases the capacity of the variable capacitor when the frequency of the adjacent interference signal is higher than that of an interested channel signal and reduces the capacity of the variable capacitor when the frequency of the adjacent interference signal is lower than that of the interested channel signal.

19. A method of adaptive filtering for attenuating an adjacent interference signal included in an RF signal using an analog filter comprising a variable capacitor, comprising:
receiving the RF signal;
determining whether an interested channel signal packet is received by being included in the RF signal;
comparing an energy level of the RF signal with a predetermined threshold when the interested channel signal packet is not received;
detecting the adjacent interference signal when the energy level of the received signal is higher than the threshold; and
attenuating the detected adjacent interference signal by adjusting a passband of the analog filter according to a frequency of the adjacent interference signal.

20. The method of adaptive filtering according to claim 19, wherein attenuating the detected adjacent interference signal by adjusting the passband of the analog filter adjusts the passband of the analog filter by increasing a capacity of the variable capacitor when the frequency of the adjacent interference signal is higher than that of an interested channel signal and reducing the capacity of the variable capacitor when the frequency of the adjacent interference signal is lower than that of the interested channel signal.

21. The method of adaptive filtering according to claim 20, further comprising:
returning the capacity of the variable capacitor to an initial value when the reception of the interested channel signal packet is completed.

22. The method of adaptive filtering according to claim 20, further comprising:
returning the capacity of the variable capacitor to an initial value when the adjacent interference signal included in the RF signal is reduced to below a predetermined level.
